(19) United States
(12) Patent Application Publication
(10) Pub. No.: US 2024/0365766 A1
(43) Pub. Date: Nov. 7, 2024

(54) Blue Sticky Fly Glue Board with Black Lines

(71) Applicant: Florida Insect Control Group LLC, Gainesville, FL (US)

(72) Inventors: Philip G. Koehler, Gainesville, FL (US); Enrico Paolo Levi, Modena (IT)

(21) Appl. No.: 18/650,815

(22) Filed: Apr. 30, 2024

Related U.S. Application Data
(60) Provisional application No. 63/463,456, filed on May 2, 2023.

(51) Int. Cl. A01M 1/14; A01M 1/16

(52) U.S. Cl. CPC A01M 1/145; A01M 1/165

(57) ABSTRACT

Systems, devices, and methods for providing a calendar configuration for a multi-sheet fly trap, with each sheet having a sticky exposed surface of a plastic or paper sheet, which is exposed when the covering sheet is removed, each sheet includes patterns of spaced apart black lines over a different colored surface. The black lines sized to emulate cracks or surface edges to attract the flies thereon. And the sticky sheets can be left up for a period of time from a day to a month, and then be ripped off and discarded.

### CROSS REFERENCE TO RELATED APPLICATIONS

This application claims the benefit of priority to U.S. Provisional Application Ser. No. 63/463,456 filed May 2, 2024, the entire disclosure of which is incorporated herein by specific reference thereto.

### FIELD OF INVENTION

This invention relates to fly traps, and in particular to systems, devices, and methods for providing a calendar configuration for a multi-sheet fly trap, with each sheet having a sticky exposed surface on a plastic or paper sheet, which is exposed when the covering sheet is removed, and each sheet having patterns of spaced apart black lines over a blue surface, which the black lines sized to emulate cracks or surface edges to attract the flies thereon, and the sticky sheets can be left up for a period of time from a day to a month, to a year, and then be ripped off and discarded.

### BACKGROUND AND PRIOR ART

Sticky fly paper has been available for over a century. See for example, U.S. Pat. No. 417,400 to Thum, which was granted in 1889. However, these traditional sticky fly papers are restricted primarily to a single sheet/board having a sticky surface that when exposed causes flies that are on the sticky surface to become trapped.

Traditional sticky fly paper uses a uniform colored surface as the sticky surface, which generally only works when the flies land on the sticky surface or fly close to the sticky surface. Additionally, the prior art is limited to a one time use for the sticky paper, and not to plural stackable sticky fly paper applications.

One of the subject inventors developed a “Fly Attractant System with Toxicant Treated Cords” in U.S. Pat. No. 9,089,121 to Diclaro, II et al., which is incorporated by reference. However, this device used black cords that were treated with toxicants over a blue colored background, and was NOT used to trap live insects. Instead, this device used the toxicant treated cords to kill the insects with insecticidal bait.

Thus, the need exists for solutions to the above problems with the prior art.

### SUMMARY OF THE INVENTION

A primary objective of the present invention is to provide a calendar configuration for a multi-sheet fly trap, with each sheet having a sticky exposed surface on a plastic or paper sheet, which is exposed when the covering sheet is removed, and each sheet having patterns of spaced apart black lines over a different color surface, with the black lines sized to emulate cracks or surface edges to attract the flies thereon, and the sticky sheets can be left up for a period of time from a day to a month, and then be ripped off and discarded.

A preferred embodiment includes grids of black lines over a blue colored background on each sheet, having a sticky surface. And a peelable layer over each sticky surface.

Further objects and advantages of this invention will be apparent from the following detailed description of the presently preferred embodiments which are illustrated schematically in the accompanying drawings.

### BRIEF DESCRIPTION OF THE FIGURES

The drawing figures depict one or more implementations in accord with the present concepts, by way of example only, not by way of limitations. In the figures, like reference numerals refer to the same or similar elements.

FIG. 1 is a first embodiment showing a grid pattern for a single sticky surface sheet for a calendar shaped configuration for the blue sticky fly glue board with black lines.

FIG. 2 is a second embodiment showing a plural parallel vertical spaced apart line pattern for a single sticky surface sheet for a calendar shaped configuration for the blue sticky fly glue board with black lines.

FIG. 3 is a third embodiment showing a plural horizontal spaced apart line pattern for a single sticky surface sheet for a calendar shaped configuration for the blue sticky fly glue board with black lines.

FIG. 4 is a bar graph of the results of a 2021 Fly Capture Experiments.

FIG. 5A shows an image of black line pattern over blue background used in the 2021 Capture Experiments.

FIG. 5B shows an image of black line pattern over a yellow background used in the 2021 Capture Experiments.

FIG. 6 is a bar graph of the results of a 2022 Fly Capture Experiments.

FIG. 7A shows an image of white line pattern over a black background used in the 2022 Capture Experiments.

FIG. 7B shows an image of blue line pattern over a yellow background used in the 2022 Capture Experiments.

FIG. 7C shows an image of black line pattern over a yellow background used in the 2022 Capture Experiments.

### DESCRIPTION OF THE PREFERRED EMBODIMENTS

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

In the Summary above and in the Detailed Description of Preferred Embodiments and in the accompanying drawings, reference is made to particular features (including method steps) of the invention. It is to be understood that the disclosure of the invention in this specification does not include all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

In this section, some embodiments of the invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art. Like numbers refer to like elements throughout, and prime notation is used to indicate similar elements in alternative embodiments.

Other technical advantages may become readily apparent to one of ordinary skill in the art after review of the following figures and description.

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise specifically noted, articles depicted in the drawings are not necessarily drawn to scale.

Although specific advantages have been enumerated above, various embodiments may include some, none, or all of the enumerated advantages.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps.

Additionally, steps may be performed in any suitable order. As used in this document, “each” refers to each member of a set or each member of a subset of a set.

The embodiments describe different versions of a calendar configuration of a plurality of glue boards and/or sticky sheets with different patterns of black lines over a colored background having a sticky surface.

For example, each sheet or board can be formed from paper or plastic with a surface having a solid blue color, printed with black lines. The entire surface of one side, can be covered with a sticky glue surface, so that the one side becomes a sticky fly trap.

Flies are attracted to the color blue with black lines.

Flies approach the blue and either think the black area is a crack or edge of a surface. So, the flies will then land on the blue right next to the black lines

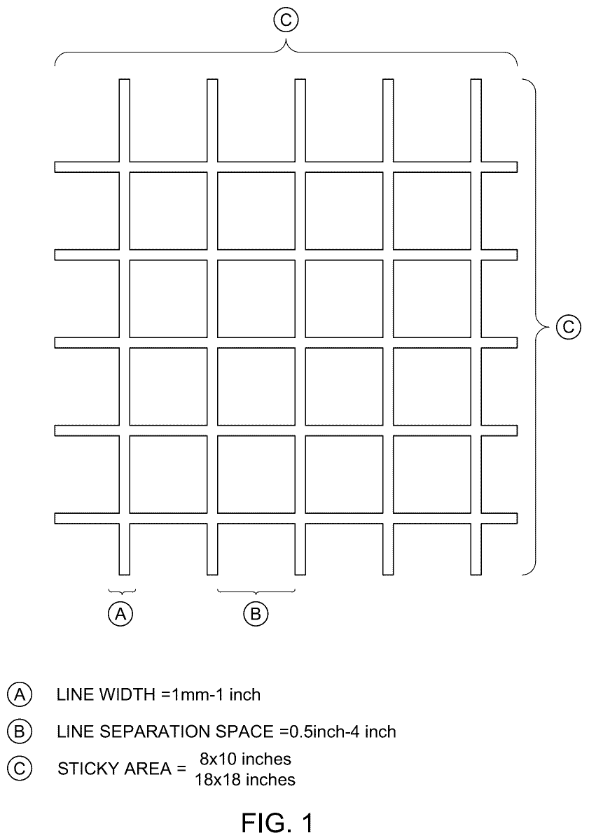

FIG. 1 is a first embodiment showing a black line grid pattern for a single sticky surface sheet for a calendar shaped configuration for the blue sticky fly glue board with black lines.

The grid pattern can include individual black lines A, each having a line width of approximately 1 mm to approximately 1 inch. The separation space B, between the black lines can be between approximately 0.5 inches to approximately 6 inches.

The sticky surface area for each sheet/board can be approximately 8 inches by approximately 10 inches.

Additionally, the sticky surface area C, for each sheet/board can be approximately 18 inches by approximately 18 inches.

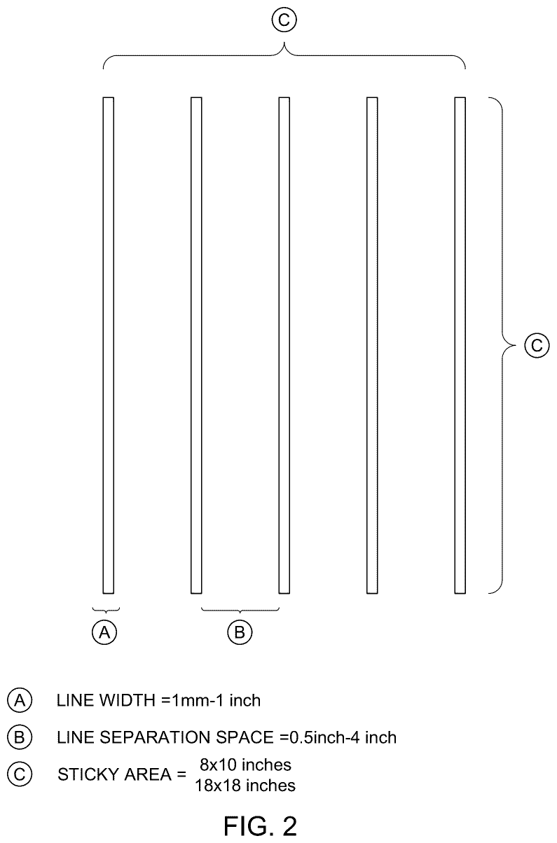

FIG. 2 is a second embodiment showing a plural parallel vertical spaced apart black line pattern for a single sticky surface sheet/board for a calendar shaped configuration for the blue sticky fly glue board with black lines.

Each black line can have a width A, between approximately 1 mm to approximately 1 inch. The separation space B, between the lines can be between approximately 0.5 inches to approximately 1 inch.

The sticky surface area C for each sheet/board can be approximately 8 inches by approximately 10 inches.

Additionally, the sticky surface area for each sheet can be approximately 18 inches by approximately 18 inches.

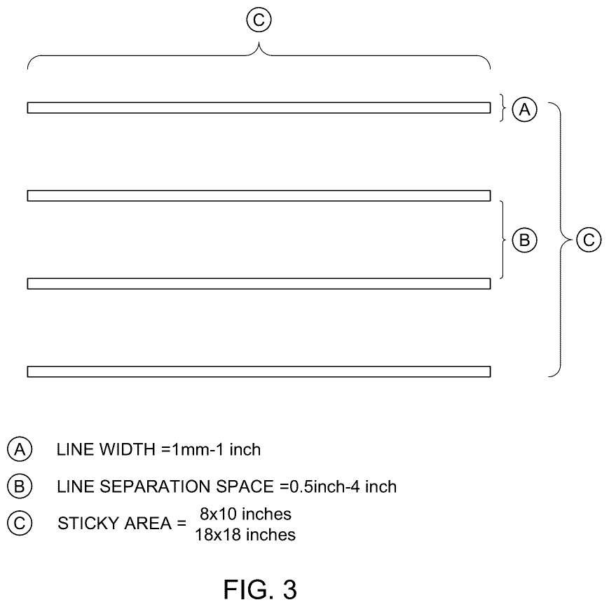

FIG. 3 is a third embodiment showing a plural horizontal spaced apart black line pattern for a single sticky surface sheet/board for a calendar shaped configuration for the blue sticky fly glue board with black lines.

Each black line can have a width A, between approximately 1 mm to approximately 1 inch. The separation space B, between the lines can be between approximately 0.5 inches to approximately 1 inch.

The sticky surface area C for each sheet/board can be approximately 8 inches by approximately 10 inches.

Additionally, the sticky surface area for each sheet can be approximately 18 inches by approximately 18 inches.

The fly catching trap can be in the form of a flip calendar that exposes one sheet/board at a time and is hung on a wall or set on a table/desk.

The invention can be inserted into a fly light trap or inserted into a frame to be hung on a wall.

Each sheet/board can be for a selected period of time, such as but not limited to one day, one week, one month, a year, and the like.

Each sticky surface can include a peelable cover sheet, that when removed exposes the sticky surface. The peelable sheet can include, but is not limited to plastic sheath, wax paper, and the like.

Blue Sticky trap experiments were done on Jun. 9, 2021, at a screenhouse at the University of Florida, Gainesville, Florida.

About 300 house flies were released into an outdoor large screened house (the screened house contained the flies in an approximately 15 by approximately 10 ft area.

The flies were left to acclimatize to the screened house for approximately 1 hour.

Colored sticky boards were hung on one of the screened walls of the room. Boards were either blue with black lines, yellow with black lines, or Black with white lines.

Boards were left to capture flies in the glue for approximately 2 hours.

Numbers of flies capture in approximately 2 hours were recorded.

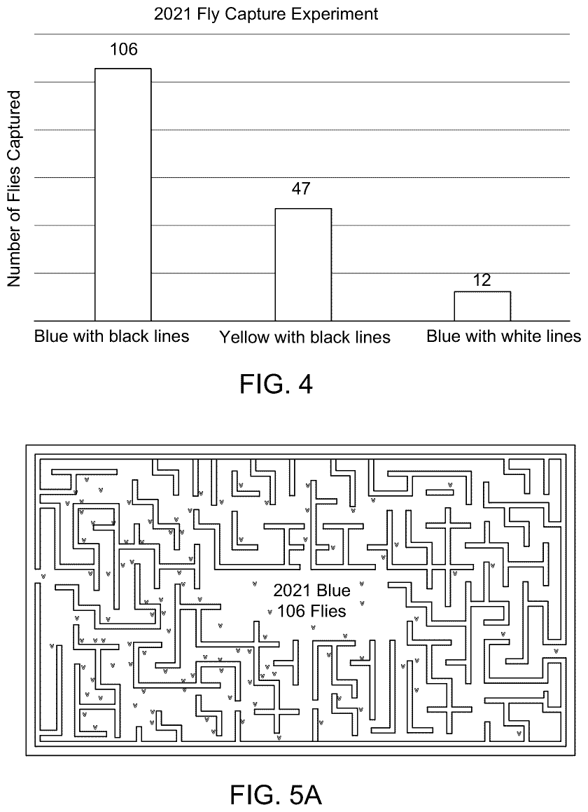

FIG. 4 is a bar graph of the results of a 2021 Fly Capture Experiment.

A total of 106 flies were caught on the blue with black lines board.

A total of 47 flies were caught on the yellow with black lines board,

A total of 12 flies were caught on the black with white lines board.

A comparison of Blue with Black lines captured shows that 2.3 times more flies than yellow with black lines, and

8.8 times more flies than Black with white lines.

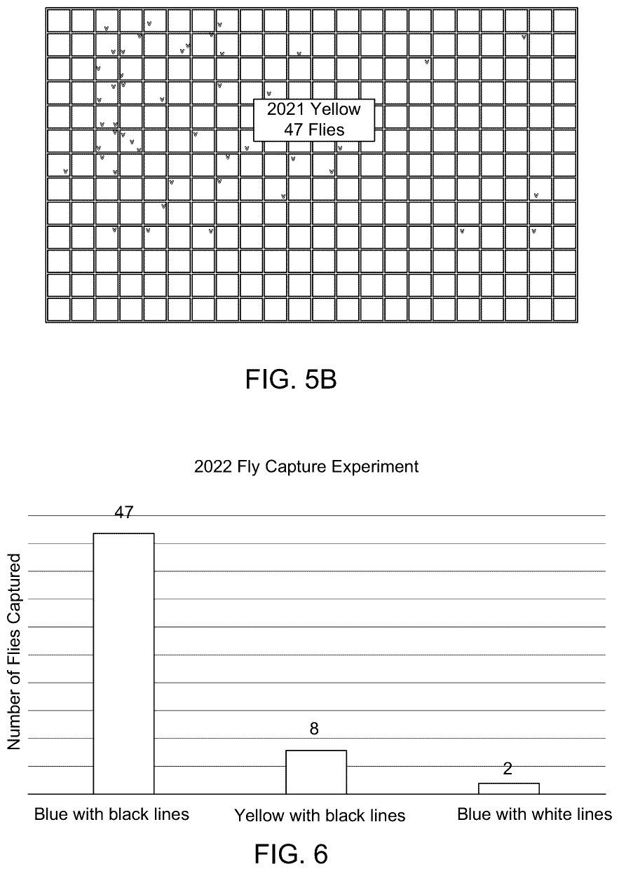

FIG. 5A shows an image of black line pattern over blue background used in the 2021 Capture Experiments.

FIG. 5B shows an image of black line pattern over a yellow background used in the 2021 Capture Experiments.

A 2022 Fly Capture Study on Colored Sticky Boards was done on Sep. 7, 2022, at a screenhouse at the University of Florida, Gainesville, Florida.

About 300 flies were released into an outdoor large screened house (the screened house contained the flies in an approximately 15 by approximately 10 ft area.

The flies were left to acclimatize to the screened house for approximately 1 hour.

Colored sticky boards were hung on one of the screened walls of the room. Boards were either blue with black lines, yellow with black lines, or Black with white lines.

Boards were left to capture flies in the glue for only approximately 30 min, because of a thunderstorm that moved into the area.

Numbers of flies capture in approximately 2 hours were recorded.

A total of 47 flies were caught on the blue background with black lines board.

A total of 8 flies were caught on the yellow background with black lines board,

A total of 2 flies were caught on the black with white lines board.

Comparing Blue with Black lines captured, showed that 5.9 times more flies than yellow with black lines, and 23.5 times more flies than Black with white lines.

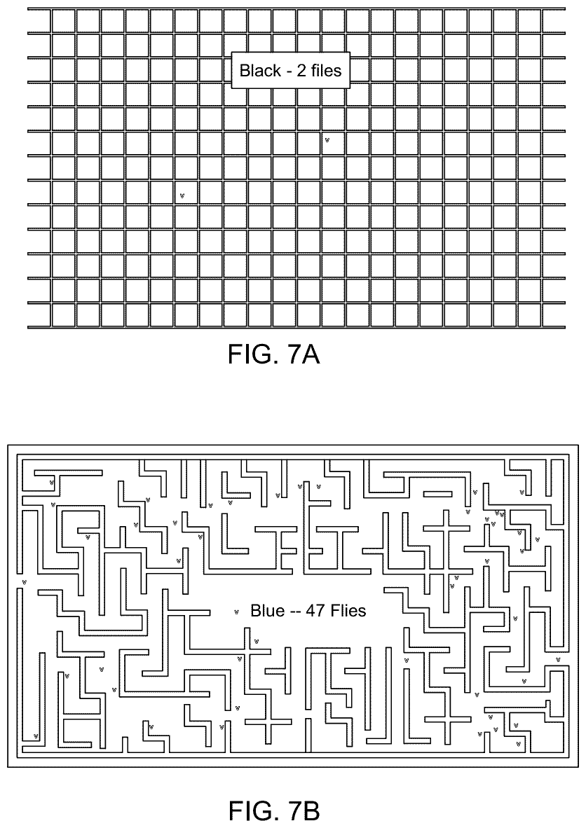

FIG. 6 is a bar graph of the results of a 2022 Fly Capture Experiments.

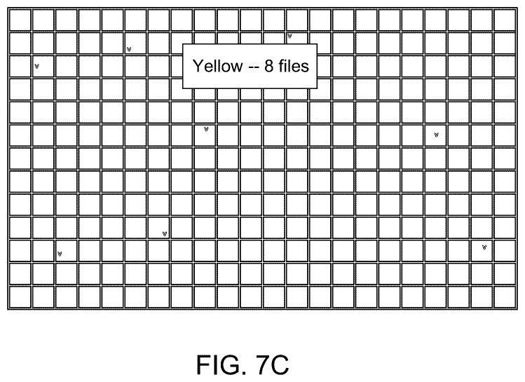

FIG. 7A shows an image of white line pattern over a black background used in the 2022 Capture Experiments.

FIG. 7B shows an image of blue line pattern over a yellow background used in the 2022 Capture Experiments.

FIG. 7C shows an image of black line pattern over a yellow background used in the 2022 Capture Experiments.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

The term “approximately” is similar to the term “about” and can be +/−10% of the amount referenced. Additionally, preferred amounts and ranges can include the amounts and ranges referenced without the prefix of being approximately.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

1. A calendar shaped fly trap device, comprising:
a plurality of single sticky surface sheets stacked together having a calendar configuration, each sheet having a pattern of black lines over a solid blue colored surface, wherein each sheet with the sticky surface is exposed for a selected period of time, and then discarded.

2. The calendar shaped fly trap device of claim 1, wherein the pattern of black lines is a grid pattern of black lines.

3. The calendar shaped fly trap device of claim 1, wherein the pattern of black lines include plural vertically spaced apart black lines.

4. The calendar shaped fly trap device of claim 1, wherein the pattern of black lines are plural spaced apart horizontal black lines.

5. The calendar shaped fly trap device of claim 1, wherein each sheet includes a glue board surface.

6. The calendar shaped fly trap device of claim 5, further comprising:
A peelable layer over the glue board surface of each sheet.

7. The calendar shaped fly trap device of claim 1, wherein each sheet is formed from plastic.

8. The calendar shaped fly trap device of claim 1, wherein each sheet is formed from paper.

9. The calendar shaped fly trap device of claim 1, wherein each black line includes a width of approximately 1 mm to approximately 1 inch.

10. The calendar shaped fly trap device of claim 1, wherein each black line includes a separation space between each line of approximately 0.5 inches to approximately 6 inches.

11. The calendar shaped fly trap device of claim 1, wherein each sheet has a sticky surface area of approximately 8 inches by approximately 10 inches.

12. The calendar shaped fly trap device of claim 1, wherein each sheet has a sticky surface area of approximately 18 inches by approximately 18 inches.

13. A calendar shaped fly trap device, comprising:
at least one single sticky surface sheet together having a calendar configuration, each sheet having a pattern of black lines over a solid colored surface, wherein each sheet with the sticky surface is exposed for a selected period of time, and then discarded.

14. The calendar shaped fly trap device of claim 13, wherein the solid colored surface includes a blue colored surface.

15. The calendar shaped fly trap device of claim 13, wherein the solid colored surface includes a yellow colored surface.

16. The calendar shaped fly trap device of claim 13, wherein each black line includes a width of approximately 1 mm to approximately 1 inch.

17. The calendar shaped fly trap device of claim 13, wherein each black line includes a separation space between each line of approximately 0.5 inches to approximately 6 inches.

18. The calendar shaped fly trap device of claim 13, further comprising:
a peelable layer over the glue board surface of each sheet.

19. The calendar shaped fly strap device of claim 13, wherein the at least one single sticky surface sheet includes a plurality of sticky surface sheets stacked together.

20. A calendar shaped fly trap device, comprising:
a plurality of single sticky surface sheets stacked together having a calendar configuration, each sheet having a pattern of black grid lines over a different colored surface, wherein each sheet with the sticky surface is exposed for a selected period of time, and then discarded; and
a peelable layer over the sticky surface of each sheet.
